(19) United States
(12) Patent Application Publication
(10) Pub. No.: US 2026/0227817 A1
(43) Pub. Date: Aug. 6, 2026

(54) A Protective Device for a Vehicle Pedal

(71) Applicant: Mariusz Stanislaw KUC, Whitefield (GB)

(72) Inventor: Mariusz Stanislaw KUC, Whitefield (GB)

(21) Appl. No.: 19/153,299

(22) PCT Filed: Feb. 2, 2024
(86) PCT No.: PCT/GB2024/050301

§ 371 Date: Aug. 1, 2025

(30) Foreign Application Priority Data
Feb. 3, 2023 (GB) 2301570.4

(51) Int. Cl. G05G 1/483; G05G 1/32; G05G 1/44

(52) U.S. Cl. CPC G05G 1/483; B60T 7/04; G05G 1/32; G05G 1/44

(57) ABSTRACT

A protective device for a motor vehicle pedal, the protective device comprising at least one fixed piercing arrangement mounted to a rear side of the vehicle pedal or lever mounting the vehicle pedal.

### TECHNICAL FIELD OF THE INVENTION

The present invention relates generally to the field of motor vehicles and more particularly to a protective device and configuration for use with a motor vehicle pedal.

### BACKGROUND TO THE INVENTION

For many people, drinking from a drinking vessel is common in a motor vehicle. The proliferation of fast food or takeaway restaurants that serve drinks in plastic bottles has only increased the number of plastic bottles which are regularly located in a motor vehicle.

Whilst many motor vehicles are provided with numerous beverage holder recesses, plastic bottle and particularly empty plastic bottles, are easily dislodged from these beverage holder recesses. This can occur by accidentally bumping them so that they become free of a beverage holder recess but also could occur if the vehicle is driven robustly, or if evasive manoeuvres are undertaken by the driver.

When a plastic bottle is not in a beverage holder recess, there is a chance that the plastic bottle could find its way into the front floor well on the driver's side of the vehicle. If this occurs, a plastic bottle can easily become positioned between one or more of the pedals used to operate the brake, accelerator or clutch of the vehicle.

All three pedals may be provided at a lower end of an elongate mounting lever which is pivotally mounted for depression, and which extends downwardly into the foot well on the driver's side to make the pedal accessible for the driver. At the very least, the vehicle brake pedal is mounted in this manner.

If a plastic bottle becomes positioned between the rear of the pedal and/or the mounting lever, then that may prevent depression or reduce the amount of depression of the pedal which adversely affects the driver's ability to control vital aspects of the vehicle's operation.

It is even more problematic if the plastic bottle is sealed, as the bottle is resistant to crushing when the cap is on as any air inside the plastic bottle cannot escape. Still further, if a plastic bottle is capped and left in a vehicle and warms up, the plastic bottle is still more resistant to crushing.

### SUMMARY OF THE INVENTION

According to one aspect, there is provided a protective device for a motor vehicle pedal, the protective device comprising at least one fixed piercing arrangement mounted to a rear side of the vehicle pedal or lever mounting the vehicle pedal.

In another aspect, there is provided a vehicle pedal comprising a protective device comprising at least one fixed piercing arrangement mounted to a rear side of the vehicle pedal.

In another aspect, there is provided a lever mounting comprising a protective device comprising at least one fixed piercing arrangement mounted to a rear side of the lever mounting the vehicle pedal.

Providing a protective device with at least one fixed piercing arrangement mounted to a rear side of the vehicle pedal or lever mounting the vehicle pedal will pierce a plastic bottle that becomes positioned between the rear of the vehicle pedal and a surface in the foot well of the vehicle.

The device is protective in the sense that it acts to pierce a plastic bottle (or any other article) which may obstruct the depression of any one or more of the pedals used to control the vehicle. This acts to protect the driver in a situation in which control is required, but which may be prevented if a plastic bottle (or any other article) obstructs the depression of any one or more of the pedals. The device of the invention preferably pierces the plastic bottle (or other article) allowing further force to be applied to the pedal to crush the plastic bottle (or other article) and normal use of the pedal. The device therefore protects the safety of the vehicle and its occupants, not the pedal itself.

The device preferably acts by first clamping the plastic bottle (or other article) against the floor and/or wall of the footwell where, the at least one fixed piercing arrangements can then pierce the plastic bottle (or other article).

The device may be provided in a retrofit configuration or may be provided in an OEM configuration when the vehicle pedal and/or elongate lever is manufactured. One difference between the two configurations may be the mounting of the at least one fixed piercing arrangement. The retrofit configuration may be provided in a configuration to be attached to the pedal and/or elongate lever and the OEM configuration may be integrally formed with the pedal and/or elongate lever.

The protective device includes at least one fixed piercing arrangement mounted to a rear side of the vehicle pedal or lever mounting the vehicle pedal.

The piercing arrangement may be mounted to a rear side of the pedal, a rearward side of the elongate lever mounting the pedal or to both. The piercing arrangement mounted to the rear side of the pedal may differ in configuration to the piercing arrangement mounted to the rear side of the elongate lever.

The piercing arrangement mounted to the rear side of the pedal may be attached to or extend from a rear surface of the pedal, extending rearwardly. The piercing arrangement mounted to the rear side of the pedal may extend substantially perpendicularly from the rear surface of the pedal. The piercing arrangement mounted to the rear side of the pedal may extend from a rear side of the pedal on either side of the elongate lever attachment to the pedal.

The piercing arrangement mounted to the rear side of the pedal may comprise a plurality of piercing elements or formations. The piercing elements or formations are preferably provided in a series or array to maximise the effect, but an irregular configuration could be used. Any number of piercing elements or formations may be provided. For example, several piercing elements or formations could be provided in a line on either side of the elongate lever attachment to the pedal. In an alternate embodiment, two or more lines of several piercing elements or formations could be provided on either side of the elongate lever attachment to the pedal.

The piercing arrangement may be provided as a plate or similar with the plurality of piercing elements or formations extending therefrom, with the plate or similar being configured to be attached to a rear side of the pedal. Any method of attachment may be used. This may be preferred for the retrofit configuration.

Alternatively, the plurality of piercing elements or formations may be formed integrally with the pedal body and extend from a rear of the pedal body. This may be preferred for the OEM configuration.

The piercing arrangement mounted to the rear side of the elongate lever may be attached to or extend from a rear surface of the elongate lever, extending rearwardly. The piercing arrangement mounted to the rear side of the elongate lever may extend substantially perpendicularly from the rear surface of the elongate lever. The piercing arrangement mounted to the rear side of the elongate lever may extend from a rear side of the elongate lever along the spine of the elongate lever and/or laterally at an angle on either side of the spine.

The piercing arrangement mounted to the rear side of the elongate lever may comprise a plurality of piercing elements or formations. The piercing elements or formations are preferably provided in a series or array to maximise the effect, but an irregular configuration could be used. Any number of piercing elements or formations may be provided. For example, several piercing elements or formations could be provided in a line down the spine of the elongate lever. Any one or more of the piercing elements or formations may extend at an angle, for example, each other piercing element or formation may extend at an acute angle in opposite sides of the elongate lever.

The piercing arrangement may be provided as a cuff or similar with a plurality of piercing elements or formations extending therefrom, with the cuff or similar being configured to be attached to the elongate lever. This may be preferred for the retrofit configuration.

Alternatively, the plurality of piercing elements or formations may be formed integrally with the elongate lever and extend from a rear of the elongate lever. This may be preferred for the OEM configuration.

Each piercing element or formation may preferably be pointed or tapering to a piercing tip. Each piercing element or formation may have a 3-dimensional shape such as conical or pyramidal. If pyramidal, one of the dimensional may be much smaller than the other two dimensions, making a pyramidal piercing element or formation which is blade-like. One or more edges of the piercing element or formation may be sharpened to increase the piercing effectiveness.

In one embodiment, blade-like piercing elements or formations may be preferred on the elongate lever and conical piercing elements or formations may be preferred extending from the rear side of the pedal.

The provision of blade-like piercing elements or formations on the elongate lever and conical piercing elements or formations extending from the rear side of the pedal combines the best features of both configurations and may provide a more effective arrangement than just at least one fixed piercing arrangement mounted to a rear side of the vehicle pedal or the elongate lever mounting the vehicle pedal.

### DETAILED DESCRIPTION OF THE INVENTION

In order that the invention may be more clearly understood one or more embodiments thereof will now be described, by way of example only, with reference to the accompanying drawings, of which:

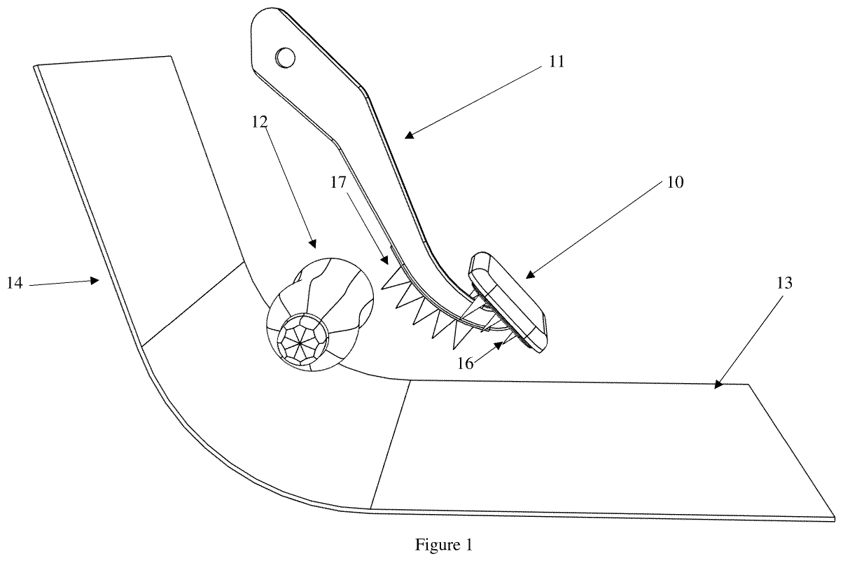

FIG. 1 is an isometric schematic view of the protective device of an embodiment in use.

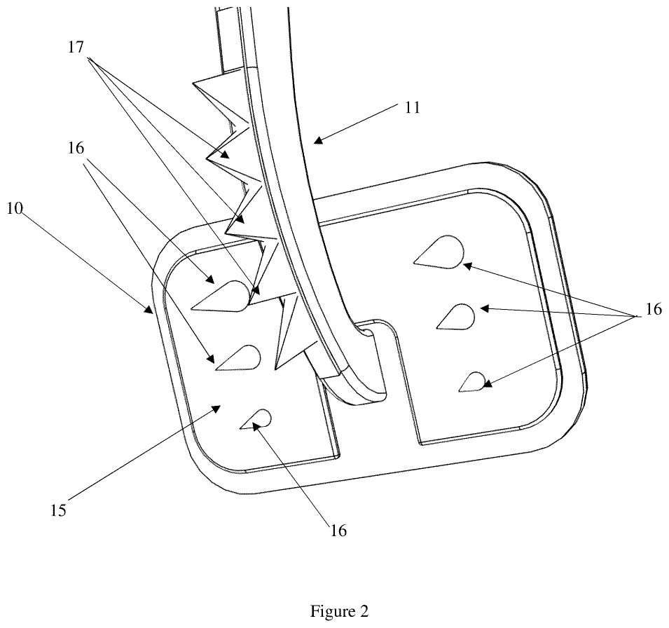

FIG. 2 is a rear view of a protective device of an embodiment.

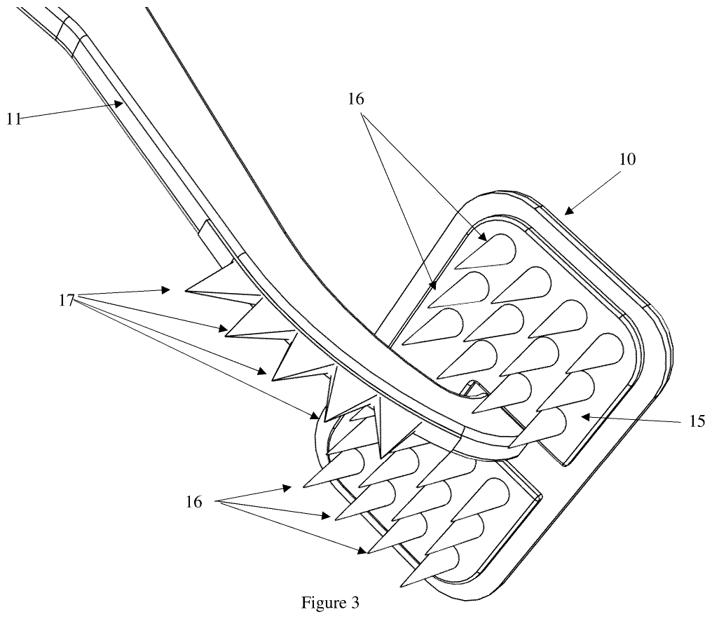

FIG. 3 is an isometric rear view of the protective device illustrated in FIG. 1.

According to one aspect, there is provided a protective device for a motor vehicle pedal. As shown in the illustrated embodiments, the protective device comprises at least one fixed piercing arrangement mounted to a rear side of the vehicle pedal 10 or elongate lever 11 mounting the vehicle pedal 10.

As shown in FIG. 1, the at least one fixed piercing arrangement will pierce a plastic bottle 12 that becomes positioned between the rear of the vehicle pedal 10 or the elongate lever 11 and a surface in the foot well of the vehicle. The device acts by first clamping the plastic bottle 12 against the floor 13 and/or wall 14 of the footwell where the piercing arrangements can then pierce the plastic bottle 12 when the pedal is depressed, at first cutting or piercing the bottle 12 allowing further force to crush the bottle 12.

The device may be provided in a retrofit configuration or may be provided in an OEM configuration when the vehicle pedal and/or elongate lever is manufactured. One difference between the two configurations may be the mounting of the at least one fixed piercing arrangement. The retrofit configuration may be provided in a configuration to be attached to the pedal and/or elongate lever and the OEM configuration may be integrally formed with the pedal and/or elongate lever.

The piercing arrangement may be mounted to a rear side of the pedal 10, a rearward side of the elongate lever mounting the pedal 11 or as shown in the accompanying Figures, to both. The piercing arrangement mounted to the rear side of the pedal 10 may differ in configuration to the piercing arrangement mounted to the rear side of the elongate lever 11, as shown.

The piercing arrangement mounted to the rear side of the pedal 10 may be attached to or extend from a rear surface of the pedal 10, extending rearwardly. The piercing arrangement may be provided as a plate or insert 15 with a plurality of preferably conical piercing elements or formations 16 extending therefrom as shown in FIGS. 1 to 3. The plate or insert 15 is configured to be attached to a rear side of the pedal 10 as shown in FIGS. 2 and 3 particularly. This may be preferred for the retrofit configuration.

The conical piercing elements or formations 16 mounted to the rear side of the pedal 10 may extend substantially perpendicularly from the rear surface of the pedal 10. As shown, the piercing elements or formations 16 mounted to the rear side of the pedal extend from a rear side of the pedal 10 on either side of the elongate lever 11 attachment to the pedal 10.

Any number of piercing elements or formations 16 may be provided. For example, several piercing elements or formations 16 could be provided in a line on either side of the elongate lever 11 attachment to the pedal 10 as shown in FIG. 2. In an alternate embodiment illustrated in FIG. 3, two or more lines of several piercing elements or formations 16 1could be provided on either side of the elongate lever 1 attachment to the pedal 10.

Alternatively, the plurality of piercing elements or formations 16 may be formed integrally with the pedal body and extend from a rear of the pedal body. This may be preferred for the OEM configuration.

The piercing elements or formations 17 mounted to the rear side of the elongate lever 11 may be attached to or extend from a rear surface of the elongate lever 11, extending rearwardly. As shown, the piercing elements or formations 17 mounted to the rear side of the elongate lever 11 extend substantially perpendicularly from the rear surface of the elongate lever 11. The piercing elements or formations 17 mounted to the rear side of the elongate lever extend from a rear side of the elongate lever along the spine of the elongate lever 11.

Any number of piercing elements or formations 17 may be provided. For example, several piercing elements or formations 17 could be provided in a line, down the spine of the elongate lever 11 as shown.

The piercing arrangement may be provided as a cuff or similar with the plurality of piercing elements or formations 17 extending therefrom, with the cuff or similar being configured to be attached to the elongate lever 11. This may be preferred for the retrofit configuration.

Alternatively, the plurality of piercing elements or formations 17 may be formed integrally with the elongate lever and extend from a rear of the elongate lever, as shown. This may be preferred for the OEM configuration.

As shown, each piercing element or formation 16, 17 is pointed or tapers to a piercing tip. Each piercing element or formation 16, 17 has a 3-dimensional shape such as conical (for element or formation 16) or pyramidal (element or formation 17). If pyramidal, one of the dimensions is much smaller than the other two dimensions, making a pyramidal piercing element or formation 17 which is blade-like. One or more edges of the piercing element or formation 17 may be sharpened to increase the piercing effectiveness.

As shown, blade-like piercing elements or formations 17 may be preferred on the elongate lever 11 and conical piercing elements or formations 16 may be preferred extending from the rear side of the pedal 10.

The provision of blade-like piercing elements or formations 17 on the elongate lever 11 and conical piercing elements or formations 16 extending from the rear side of the pedal 10 combines the best features of both configurations and may provide a more effective arrangement than just at least one fixed piercing arrangement mounted to a rear side of the vehicle pedal 10 or the elongate lever 11 mounting the vehicle pedal 10.

The one or more embodiments are described above by way of example only. Many variations are possible without departing from the scope of protection afforded by the appended claims.

1. A protective device for a motor vehicle pedal, the protective device comprising at least one fixed piercing arrangement mounted to a rear side of the vehicle pedal or lever mounting the vehicle pedal.

2. The protective device for a motor vehicle pedal as claimed in claim 1 provided in a retrofit configuration to be attached to the pedal and/or elongate lever.

3. The protective device for a motor vehicle pedal as claimed in claim 1 provided in an OEM configuration at least one fixed piercing arrangement integrally formed with a rear side of the vehicle pedal or lever mounting the vehicle pedal when the vehicle pedal and/or elongate lever is manufactured.

4. The protective device for a motor vehicle pedal as claimed in claim 1 comprising an at least one fixed piercing arrangement mounted to both the rear side of the pedal and the rearward side of the elongate lever mounting the pedal.

5. The protective device for a motor vehicle pedal as claimed in claim 1 wherein the piercing arrangement mounted to the rear side of the pedal extends rearwardly from a rear surface of the pedal.

6. The protective device for a motor vehicle pedal as claimed in claim 1 wherein the piercing arrangement mounted to the rear side of the pedal extends substantially perpendicularly from a rear surface of the pedal.

7. The protective device for a motor vehicle pedal as claimed in claim 1 wherein the piercing arrangement mounted to the rear side of the pedal extends on either side of the elongate lever.

8. The protective device for a motor vehicle pedal as claimed in claim 1 wherein the piercing arrangement mounted to the rear side of the pedal comprises a plurality of piercing elements or formations.

9. The protective device for a motor vehicle pedal as claimed in claim 8 wherein the piercing elements or formations are provided in a series or array to maximise the effect.

10. The protective device for a motor vehicle pedal as claimed in claim 9 wherein several piercing elements or formations are provided in a line on either side of the elongate lever.

11. The protective device for a motor vehicle pedal as claimed in claim 9 wherein two or more lines of several piercing elements or formations are provided on either side of the elongate lever.

12. The protective device for a motor vehicle pedal as claimed in claim 8 provided as a plate with the plurality of piercing elements or formations extending therefrom, with the plate configured to be attached to a rear side of the pedal.

13. The protective device for a motor vehicle pedal as claimed in claim 8 wherein the plurality of piercing elements or formations are formed integrally with a pedal body and extend from a rear of the pedal body.

14. The protective device for a motor vehicle pedal as claimed in claim 1 wherein the piercing arrangement mounted to the rear side of the elongate lever extends rearwardly from a rear surface of the elongate lever,

15. The protective device for a motor vehicle pedal as claimed in claim 14 wherein the piercing arrangement mounted to the rear side of the elongate lever extends substantially perpendicularly from the rear surface of the elongate lever.

16. The protective device for a motor vehicle pedal as claimed in claim 14 wherein the piercing arrangement mounted to the rear side of the elongate lever extends from a rear side of the elongate lever along a spine of the elongate lever and/or laterally at an angle on either side of the spine.

17. The protective device for a motor vehicle pedal as claimed in claim 16 wherein several piercing elements or formations are provided in a line down the spine of the elongate lever.

18. The protective device for a motor vehicle pedal as claimed in claim 14 wherein the piercing arrangement is provided as a cuff configured to be attached to the elongate lever, with a plurality of piercing elements or formations extending therefrom.

19. The protective device for a motor vehicle pedal as claimed in claim 14 wherein the plurality of piercing elements or formations are formed integrally with the elongate lever and extend from a rear of the elongate lever.

20. The protective device for a motor vehicle pedal as claimed in claim 8 wherein each piercing element or formation is pointed or tapers to a piercing tip.

21. (canceled)

22. (canceled)

23. (canceled)

24. (canceled)

25. (canceled)
